(19) United States
(12) Patent Application Publication
(10) Pub. No.: US 2009/0172759 A1
(43) Pub. Date: Jul. 2, 2009

(54) Wireless USB modem device supporting dual service for portable internet and digital broadcasting

(76) Inventor: Jung-Hoon Jung, Gyeonggi-do (KR)

Correspondence Address: COOPER & DUNHAM, LLP, 30 Rockefeller Plaza, 20th Floor, NEW YORK, NY, 10112, US

(21) Appl. No.: 12/077,549

(22) Filed: Mar. 20, 2008

(30) Foreign Application Priority Data
Dec. 28, 2007 (KR) 10-2007-0139781

(51) Int. Cl. H04N 7/173

(52) U.S. Cl. 725/111

(57) ABSTRACT

The present invention relates to a wireless USB modem device supporting dual service for portable Internet and digital broadcasting. The wireless USB modem device includes a portable Internet communication module and a digital broadcast reception module. The wireless USB modem device includes a USB hub connected to USB interfaces of both the portable Internet communication module and the digital broadcast reception module, and configured to relay data to a user terminal. A switching mode power supply unit is implemented in a DC-DC switching mode, is supplied with power from the user terminal and is configured to apply power to the portable Internet communication module and the digital broadcast reception module so that the portable Internet communication module and the digital broadcast reception module can be simultaneously driven. Accordingly, a separate control unit for controlling USB interfaces is not required, and the number of peripherals connected to the USB port of the portable user terminal can be reduced. Further, portable Internet service and digital broadcasting service can be simultaneously provided, thus enabling bidirectional digital multimedia broadcasting service and Internet service to be simultaneously supported anytime and anywhere without regard to spatial or temporal restrictions.

### BACKGROUND OF THE INVENTION

1. Field of the Invention

The present invention relates, in general, to a wireless Universal Serial Bus (hereinafter referred to as a “USB”) modem supporting dual service for portable Internet and digital broadcasting, and, more particularly, to, a USB modem, which can simultaneously support both a personal portable Internet service and a personal portable digital broadcasting service using a USB mode.

2. Description of the Related Art

With the rapid development of electro-communication technology, personal portable Internet communication service has developed into low-speed second generation Code Division Multiple Access (CDMA), a Global System for Mobile communications (GSM), medium-speed third generation CDMA Evolution of Data Only (EV-DO), Wide-band Code Division Multiple Access (WCDMA), and 3.5-th generation High-Speed Downlink Packet Access (HSDPA)/High-Speed Uplink Packet Access (HSUPA), Long Term Evolution (LTE) Wireless Broadband Internet (WIBRO), and Wireless Metropolitan Area Network (WiMAX), and thus Internet service can be provided without regard to temporal and spatial restrictions.

Further, standards are also emerging for personal portable digital broadcasting (so-called “mobile TV”) technology, which enables the reception of digital broadcasts when traveling, for example, Terrestrial-Digital Multimedia Broadcast (T-DMB; Korea), Digital Video Broadcasting-Handheld (DVB-H; Europe), Integrated Service Digital Broadcasting-Terrestrial (ISDB-T; Japan), Media Forward Link Only (MediaFLO; the United States), for respective countries, and thus digital broadcasting service can be provided without regard to temporal and spatial restrictions.

In order to provide these services through a portable user terminal having various forms, such as a notebook computer, a Personal Digital Assistant (PDA), and a handheld Personal Computer (PC), products can be configured using USB, among a plurality of interfaces. However, USB supports a subordinate structure in which a user terminal always acts as a host, and peripherals act as clients and are subordinated to and connected to the host, the host supervising all management operations.

As described above, since USB connection must be achieved based on a subordinate relationship, a USB device desired to connect to the USB of a portable user terminal acting as the host is required to be directly connected to the USB port of the portable terminal. Therefore, in order to provide the function of a personal portable digital broadcast receiver to a personal portable USB Internet modem provided with only a single USB port, the internal control unit of the device is designed, and USB interfaces for respective services are selectively switched at the request of a user, so that corresponding services must be provided by providing connections between respective USB interfaces and the USB port of the portable user terminal acting as the host.

Further, due to the environment of USB power (2500 mW/5 V) of the portable user terminal used as the host, the provision of dual service for the personal portable Internet and personal portable digital broadcasting, which require high speed/large capacity transmission, is limited, and thus services must be selectively provided. Accordingly, it is impossible to provide bidirectional digital multimedia broadcasting service requiring the simultaneous provision of both types of services.

Meanwhile, when an additional function using a USB interface, other than the function of a conventional USB wireless Internet modem, is provided in the conventional USB wireless Internet modem, a method of configuring a mechanical switch and a control circuit, connecting a USB interface for a desired function to the USB interface of a host, and providing a necessary function, is used. That is, the conventional USB wireless Internet modem has a structure in which a user inevitably selects one from two functions and uses the selected function, so that it is impossible to provide real-time dual mode service for various types of multimedia service based on information communication technology, which is rapidly developing at the present time.

Further, when a power design method using an existing Low Drop Output (LDO) regulator is used, power supplied by a host USB is limited (5V@500 mA). As a result, when two functions are provided using a single USB port, power deficiency occurs, thus making it impossible to simultaneously provide both functions.

A power circuit design based on LDO is disadvantageous in that, when power from the host is supplied, linear output is continuously generated, so that power consumption is high, and in that, as current consumption increases, power, indicating the product of voltage and current, increases, and voltage loss increases due to a voltage drop attributable to power conversion, so that efficiency of power use is greatly deteriorated, thus enabling less than 50% of the supplied voltage to be used.

### SUMMARY OF THE INVENTION

Accordingly, the present invention has been made keeping in mind the above problems occurring in the prior art, and an object of the present invention is to provide a wireless USB modem device supporting dual service for portable Internet and digital broadcasting, which implements a Multi-Mode (MM) device, in which a personal portable Internet communication module and a personal portable digital broadcast reception module, which use USB interfaces, are provided, and in which two types of service functions are implemented and operated using a single device, so that efficiency of power use is improved, thus simultaneously providing a personal portable Internet communication service function and a personal portable digital broadcasting service function.

In order to accomplish the above object, the present invention provides a wireless Universal Serial Bus (USB) modem device supporting dual service for portable Internet and digital broadcasting, the USB modem device including a portable Internet communication module and a digital broadcast reception module, comprising a USB hub connected to USB interfaces of both the portable Internet communication module and the digital broadcast reception module, and configured to relay data to a user terminal through a USB connector; and a switching mode power supply unit implemented in a DC-DC switching mode, supplied with power from the user terminal and configured to apply power both to the portable Internet communication module and to the digital broadcast reception module through high-speed switching of power so that the portable Internet communication module and the digital broadcast reception module can be simultaneously driven.

Preferably, the switching mode power supply unit may comprise a dual-output switching mode power supply unit for outputting first power to the portable Internet communication module, the digital broadcast reception module, and the USB hub, and outputting second power to the digital broadcast reception module, the first and second power being switched at high speed; and a single-output switching mode power supply unit for outputting third power to the digital broadcast reception module, the third power being switched at high speed.

Preferably, the portable Internet communication module may be implemented using one of Code Division Multiple Access (CDMA), Global System for Mobile communications (GSM), CDMA Evolution of Data Only (EV-DO), Wide-band CDMA (WCDMA), High-Speed Downlink Packet Access (HSDPA)/High-Speed Uplink Packet Access (HSUPA), Long Term Evolution (LTE), and Wireless Broadband Internet (WIBRO)/Metropolitan Area Network (WiMAX).

Preferably, the digital broadcast reception module may be implemented using one of Terrestrial-Digital Multimedia Broadcast (T-DMB), Digital Video Broadcasting-Handheld (DVB-H), Integrated Service Digital Broadcasting-Terrestrial (ISDB-T), and Media Forward Link Only (MediaFLO).

### BRIEF DESCRIPTION OF THE DRAWINGS

The above and other objects, features and other advantages of the present invention will be more clearly understood from the following detailed description, taken in conjunction with the accompanying drawings, in which:

FIG. 1 is a block diagram showing the construction of a wireless USB modem device supporting dual service for portable Internet and digital broadcasting according to an embodiment of the present invention; and

FIG. 2 is a detailed diagram showing the switching mode power supply unit of FIG. 1.

### DESCRIPTION OF THE PREFERRED EMBODIMENTS

Hereinafter, embodiments of the present invention will be described in detail with reference to the attached drawings.

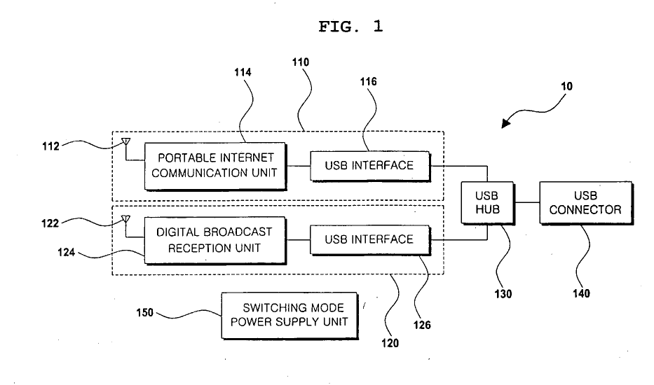

FIG. 1 is a block diagram showing the construction of a wireless USB modem device, supporting dual service for portable Internet and digital broadcasting, according to an embodiment of the present invention.

A wireless USB modem device 10, supporting dual service for portable Internet and digital broadcasting, according to an embodiment of the present invention includes a portable Internet communication module 110, supporting wireless Internet communication, a digital broadcast reception module 120, supporting digital broadcasting, a USB hub 130 connected to the USB interfaces 116 and 126 of both the portable Internet communication module 110 and the digital broadcast reception module 120 and configured to relay data to a user terminal (not shown) through a USB connector 140, the USB connector 140, connected to the user terminal, and a switching mode power supply unit 150, implemented in a DC-DC switching mode and configured to supply power to respective components.

The portable Internet communication module 110 includes an antenna 112 configured to communicate with an external wireless base station, a portable Internet communication unit 114 connected to a portable Internet communication network through the antenna 112, and a USB interface 116 configured to convert signals into USB data.

The antenna 112 receives signals output from an external wireless base station, transmits the signals to the portable Internet communication unit 114, and transmits signals received from the portable Internet communication unit 114 to the external wireless base station over a communication network.

The portable Internet communication unit 114 supports one of CDMA, GSM, CDMA EV-DO, WCDMA, HSDPA/HSUPA, LTE, and WIBRO/WiMAX, demodulates Radio Frequency (RF) signals received from the antenna 112, and performs signal processing on the RF signals based on a protocol defined in standards.

The USB interface 116 converts baseband signals, demodulated by the portable Internet communication unit 114, into USB data, transmits the USB data to the USB hub 130, converts USB data received from the USB hub 130 into baseband signals, and transmits the baseband signals to the portable Internet communication unit 114.

The digital broadcast reception module 120 includes an antenna 122 for receiving broadcasts from an external wireless broadcasting station, a digital broadcast reception unit 124 for processing the broadcasts received through the antenna 122, and a USB interface 126 for converting signals into USB data.

The antenna 122 receives the signals output from the external wireless broadcasting station, and transmits the signals to the digital broadcast reception unit 124.

The digital broadcast reception unit 124 supports a reception function using one of T-DMB, DVB-H, ISDB-T, and MediaFLO, and demodulates RF signals received from the antenna 122 and performs signal processing on the demodulated signals on the basis of a protocol defined in standards.

The USB interface 126 converts the baseband signals, demodulated by the digital broadcast reception unit 124, into USB data, and transmits the USB data to the USB hub 130.

The USB hub 130 is connected both to the USB interface 116 of the portable Internet communication module 110 and to the USB interface 126 of the digital broadcast reception module 120, and is configured to relay USB data, thereby performing a USB interface communication function together with the portable user terminal through the USB connector 140.

The USB hub 130 includes an UpStream (US) port and a DownStream (DS) port. The US port is connected,to the USB interface of a host. The DS port is configured to transmit USB data, received both from the USB interface 116, which is connected to the portable Internet communication unit 114, and from the USB interface 126, which is connected to the digital broadcast reception unit 124, to the host, thus simultaneously providing two types of functions to the user.

The USB connector 140 is connected to a portable user terminal, such as a notebook, a PDA, and a Handheld PC, and is configured to transmit or receive USB data.

The switching mode power supply unit 150 is supplied with power from the user terminal and is configured to apply power to the portable Internet communication module 110 and the digital broadcast reception module 120 through the high-speed switching of power, so that the modules 110 and 120 can be simultaneously driven.

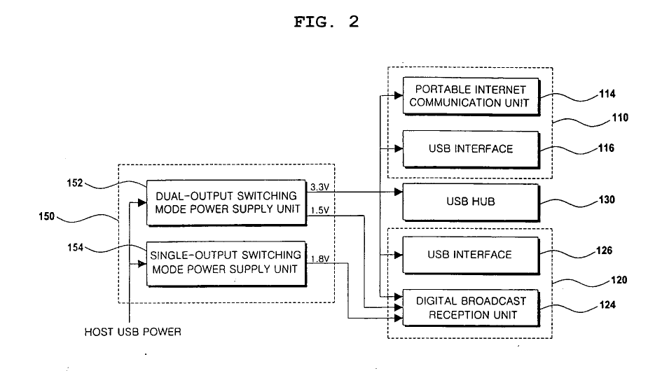

With reference to FIG. 2, the switching mode power supply unit 150 is described in detail.

FIG. 2 is a detailed diagram showing the switching mode power supply unit of FIG. 1.

The wireless USB modem device 10 improves efficiency of power use by utilizing a DC-DC switching mode as a power mode, thus simultaneously providing two types of functions for portable digital broadcasting and portable Internet through a single USB port.

As shown in FIG. 2, the switching mode power supply unit 150 includes a dual-output switching mode power supply unit 152 for outputting two types of power, and a single-output switching mode power supply unit 154 for outputting a single type of power.

The dual-output switching mode power supply unit 152 outputs first power to the portable Internet communication module 110, the digital broadcast reception module 120, and the USB hub 130, outputs second power to the digital broadcast reception module 120, and performs high-speed switching.

The single-output switching mode power supply unit 154 applies third power to the digital broadcast reception module 120, and performs high-speed switching.

In this way, the switching mode power supply unit 150 is implemented in a switching mode so that the Internet communication module 110 and the digital broadcast reception module 120 are operated within a range in which power consumption attributable to the simultaneous operation of the portable Internet communication module 110 and the digital broadcast reception module 120 does not exceed the limited USB power environment of the user terminal (2500 mW/5 V@500 mA), thus ensuring efficient use of power.

Further, the switching mode power supply unit 150 is implemented in a DC-DC switching mode, and is configured such that a pulse-shaped output voltage is generated by repeating ON/OFF switching operations using a high-speed switching frequency, and such that, when the pulse-shaped output voltage is processed by a smoothing circuit, DC power identical to the input power of the host USB of the portable user terminal is generated. Further, efficiency of power use is greatly improved through power ON/OFF operations, thus ensuring highly efficient use of power, enabling more than 90% of input power to be used.

Such a switching mode power supply unit 150 determines the point at which minimum current is consumed, and enables the point to be used for a circuit design, in order to minimize current consumption in respective functional modules while improving the efficiency of a power circuit. Accordingly, peripheral circuits irrelevant to functional operations are omitted, and optimization for minimum current consumption is realized.

Through the above construction, a personal portable Internet service and a personal portable digital multimedia broadcasting service are simultaneously provided through a single terminal using a USB hub and a switching mode power supply unit having a DC-DC switching mode, thus providing a bidirectional digital multimedia broadcasting function.

As described above, the present invention provides a wireless USB modem device, supporting dual service for portable Internet and digital broadcasting, in which a personal portable Internet communication module using a USB interface and a personal portable digital broadcast reception module using a USB interface are configured to form a subordinate relationship in the form of branches with respect to the host USB of the portable user terminal through a USB hub, and are connected to the USB port of the portable user terminal, and in which switching mode power is used so as to efficiently use the limited USB power environment (2500 mW/5 V) of the portable user terminal, so that a separate control unit for controlling USB interfaces is not required, and the number of peripherals connected to the USB port of the portable user terminal can be reduced. Further, the present invention is advantageous in that a personal portable Internet service and a personal portable digital broadcasting service can be simultaneously provided to a user, thus enabling a bidirectional digital multimedia broadcasting service and an Internet service to be simultaneously supported anytime and anywhere without regard to spatial or temporal restrictions.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless Universal Serial Bus (USB) modem device supporting dual service for portable Internet and digital broadcasting, the USB modem device including a portable Internet communication module and a digital broadcast reception module, comprising:
a USB hub connected to USB interfaces of both the portable Internet communication module and the digital broadcast reception module, and configured to relay data to a user terminal through a USB connector; and
a switching mode power supply unit implemented in a DC-DC switching mode, supplied with power from the user terminal and configured to apply power both to the portable Internet communication module and to the digital broadcast reception module through high-speed switching of power so that the portable Internet communication module and the digital broadcast reception module can be simultaneously driven.

2. The wireless USB modem device according to claim 1, wherein the switching mode power supply unit comprises:
a dual-output switching mode power supply unit for outputting first power to the portable Internet communication module, the digital broadcast reception module, and the USB hub, and outputting second power to the digital broadcast reception module, the first and second power being switched at high speed; and
a single-output switching mode power supply unit for outputting third power to the digital broadcast reception module, the third power being switched at high speed.

3. The wireless USB modem device according to claim 1, wherein the portable Internet communication module is implemented using one of Code Division Multiple Access (CDMA), Global System for Mobile communications (GSM), CDMA Evolution of Data Only (EV-DO), Wide-band CDMA (WCDMA), High-Speed Downlink Packet Access (HSDPA)/High-Speed Uplink Packet Access (HSUPA), Long Term Evolution (LTE), and Wireless Broadband Internet (WIBRO)/Metropolitan Area Network (WiMAX).

4. The wireless USB modem device according to claim 1, wherein the digital broadcast reception module is implemented using one of Terrestrial-Digital Multimedia Broadcast (T-DMB), Digital Video Broadcasting-Handheld (DVB-H), Integrated Service Digital Broadcasting-Terrestrial (ISDB-T), and Media Forward Link Only (MediaFLO).
